(19) United States
(12) Patent Application Publication
(10) Pub. No.: US 2002/0039927 A1
(43) Pub. Date: Apr. 4, 2002

(54) Torque transimission element

(75) Inventor: Knut Welke, Sulzheim (DE)

Correspondence Address: COHEN, PONTANI, LIEBERMAN & PAVANE, Suite 1210, 551 Fifth Avenue, New York, NY, 10176, US

(73) Assignee: Mannesmann Sachs AG

(21) Appl. No.: 09/900,729

(22) Filed: Jul. 5, 2001

(30) Foreign Application Priority Data
Jul. 6, 2000 (DE) 100 32 952.7

(51) Int. Cl. F16C 3/03; F16D 3/06

(52) U.S. Cl. 464/169

(57) ABSTRACT

A torque transmission element which connects a starter generator to a torque transmission unit arranged in series, wherein at least parts of the torque transmission unit are able to execute an axial operating movement relative to the starter generator, and the torque transmission element is axially elastic with respect to the series arrangement of the starter generator and the torque transmission unit. The torque transmission element is embodied as a tangential spring arm, one end of which is arranged on the starter generator and the other end of which is arranged on the torque transmission unit.

### BACKGROUND OF THE INVENTION

1. Field of the Invention

The invention relates to a torque transmission element which connects a starter generator to a torque transmission unit arranged in series, wherein at least parts of the torque transmission unit are able to execute an axial operating movement relative to the starter generator, and the torque transmission unit is axially elastic with respect to the series arrangement.

2. Description of the Related Art

Such torque transmission elements are used, for example, for connecting to one another, for the purpose of torque transmission, an electrical machine and a hydrodynamic torque converter which are arranged on a shaft in a drive train of a motor vehicle so that they experience common rotation. A hydrodynamic torque converter is described, for example, in U.S. Pat. No. 5,215,173. There is the problem that while the torque converter is operating, an increased internal pressure p builds up in its housing, as a result of which the housing of the torque converter is deformed and essentially experiences stretching in the axial direction and compression in the radial direction. Given a direct connection of the housing of the torque converter to the electrical machine, its functional elements can also be deformed, as a result of which their functions can be adversely affected or even fail. In addition to the transmission of torque, the torque transmission element therefore has the further essential function of absorbing the axial expansion of the converter housing and preventing, or significantly reducing, the transmission of the expansion to the functional elements of the electrical machine which are operatively connected to this housing.

Torque transmission elements for this purpose of use are already known to the applicant in the embodiment according to FIG. 1, which will be explained below in conjunction with reference symbols which are introduced.

The torque transmission element 1 is embodied here in the form of a disk which extends mainly in the radial direction and is composed of a flexible material, for example sheet metal. This disk comprises a radially inner section 2, a radially outer section 3 which is offset axially with respect to the latter, and a middle section 4 which connects the two aforementioned sections. The middle section 4 is inclined by an angle αwith respect to the adjacent sections 2 and 3. The radially inner and the radially outer sections 2 and 3 have openings 5 for attachment means which are used for the purpose of connection to the starter generator and to the torque transmission unit. When there is an axial force F which acts, for example, on the radially inner attachment means and starts from the functional unit attached there, for example the torque converter, the disk is deformed, in which case the absolute value of the angle αchanges and the region which extends radially inward from the radially outer attachment means and which constitutes a lever arm is deflected axially. The region of the outer attachment means remains approximately fixed here. The applicant is also aware of a simplified embodiment (not shown in the drawing) in which the torque transmission element is embodied only as a disk which extends in the radial direction and has appropriate openings for attachment means.

FIG. 2 is a sectional view of the installed situation of a known torque transmission element 1 which is described in FIG. 1 and which connects the housing 6 (illustrated on the right in FIG. 2) of a hydrodynamic torque converter to a rotor 7 (illustrated on the left) of an electrical machine which functions as a starter generator. The direction of a hydrostatic pressure p acting on the housing 6 of the torque converter is also represented.

Although the torque transmission elements described as the prior art basically fulfill the relevant requirements, they also have decisive disadvantages.

A first disadvantage results from the fact that it is necessary to provide a functional unit on the radially inner section near to the shaft. Owing to the short distance to this shaft, it is necessary to select a sufficiently large number of attachment means and/or correspondingly highly rigid attachment means in order to transmit a given torque. In order to achieve sufficient flexibility of the arrangement, it is also necessary to provide the attachment means for the functional units with the greatest possible spacing in the radial direction. As a result, such a torque transmission element is radially very large. On the other hand, given the limited radial installation space and the resulting short radial spacing between the attachment means, as illustrated for example in FIG. 2, only a very small degree of flexibility can be achieved, which can adversely affect the function and the operational reliability of the functional units connected by this torque transmission element.

### SUMMARY OF THE INVENTION

The invention is based on the object of providing a torque transmission element which is of compact design and which overcomes the aforesaid disadvantages of the prior art.

This object is achieved according to the invention by designing the torque transmission element as a tangential spring arm, one end of which is arranged on the starter generator and the other end of which is arranged on the torque transmission unit.

The basic idea of the invention is consequently to refrain from using a lever arm which extends in a disk shape in the radial direction for executing an axial compensation movement of the torque transmission element, and instead to arrange one or more individual tangential spring arms. This results in a multiplicity of advantages.

The design according to the invention then permits both functional units which are connected to the torque transmission element to be provided on essentially the same, or only slightly different, reference circles. The functional units which are coupled to a torque transmission are advantageously both connected at their radially outer regions to the torque transmission element. Owing to the relatively large distance between the attachment elements and the shaft in comparison to the torque transmission element described in the prior art, it is possible to make a correspondingly lower selection of the number of attachment elements and/or their rigidity in order to transmit torque. If the number of attachment means is reduced, this results in a significantly lower degree of expenditure on mounting with a simultaneous saving in terms of weight and costs.

The axial flexibility of the torque transmission element can be easily determined by means of the length of the tangential spring arm, and is thus independent of the properties of the material within a specific area. Given a certain desired value of the axial offset which is to be achieved, a high degree of flexibility can be realized by means of relatively long spring arms, and a low degree of flexibility by means of relatively short spring arms. This simple structural measure enables the torque transmission element to be configured in a way which is tailored to its respective specific application.

The above-mentioned feature also results in the further significant advantage that the possible selection of materials for manufacturing such a torque transmission element can be considerably widened. It is now also possible to use materials which were previously considered unsuitable owing to their low modulus of elasticity and the resulting only low degree of flexibility.

It is a particular advantage that the cross section of the tangential spring arm in the installed position is significantly larger in the radial direction than in the axial direction. This measure is suitable, either alone or as a supplement to the measures already mentioned, for adapting the flexibility of the torque transmission element to the respective requirements.

In a further preferred embodiment of a torque transmission element, one or more tangential spring arms are arranged on at least one common carrier, and the at least one carrier forms the connection to the starter generator and/or to the torque transmission unit. This entails the advantage that the number of attachment means for attaching the starter generator and/or the torque transmission unit can be significantly reduced in comparison with the number of ends of the tangential spring arms, which gives rise to remarkable savings in terms of costs and time in comparison with the mounting of individual torque transmission elements in the form of tangential spring arms.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1A is an axial section of a torque transmission element according to the prior art;

FIG. 1B is a plan view of the torque transmission element of the prior art;

FIG. 2 shows the installed situation of a torque transmission element which is operatively connected as a torque transmission unit to a starter generator and to a hydrodynamic torque converter;

FIG. 3 shows a torque transmission element according to the invention which is embodied as a tangential spring arm; and

FIG. 4 shows a torque transmission element according to the invention in which a plurality of tangential spring arms are arranged on a common carrier.

### DETAILED DESCRIPTION OF THE PRESENTLY PREFERRED EMBODIMENTS

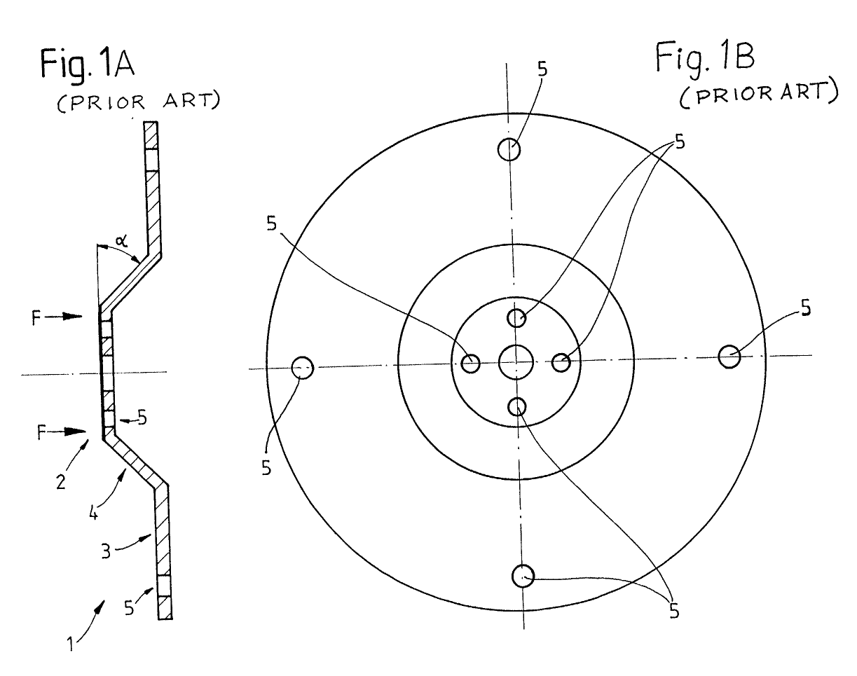

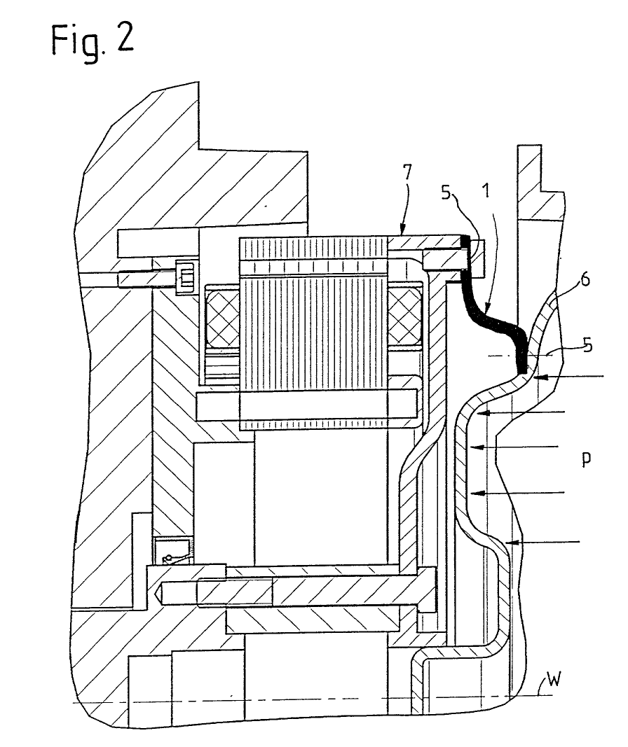

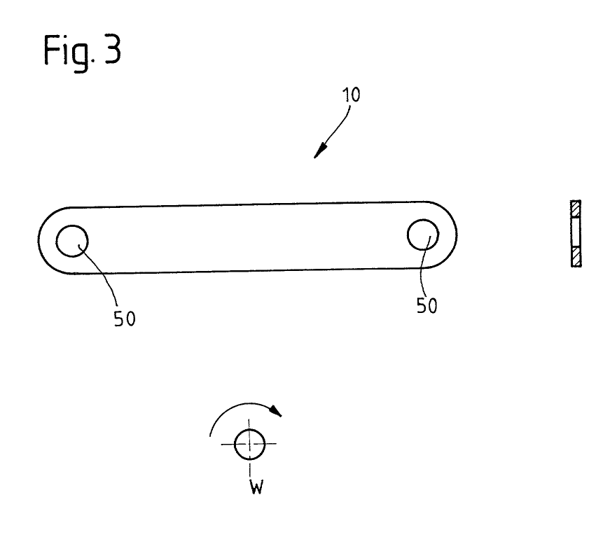

FIG. 3 shows, in a basic outline, a torque transmission element 10 corresponding to the installed situation according to FIG. 2, in the form of a spring arm which is formed from a ribbon-shaped, elastic piece of sheet metal. Features in FIG. 3 which are the same as those in FIG. 2 are indicated by adding a zero to the reference numbers. At the ends, the spring arm has openings 50 for attachment means, by which means, for the purpose of transmitting torque, the spring arm is connected on the one hand to a starter generator and on the other hand to a torque transmission unit, which are arranged on a common shaft W. In the installed position, the spring arm is arranged tangentially with respect to the shaft W, so that its cross section is significantly larger in the radial direction than in the axial direction. In this way, when an axially directed force is acting, the spring arm can execute an axial compensation movement. Instead of the straight design shown in FIG. 1, the spring arm can, for example, also be embodied in the form of a segment of a circular disk or in some other form which is tailored to the conditions of the installation space. Likewise, in FIG. 3 the end regions of the lever arm which have the openings 50 may be axially offset or their position may be rotated.

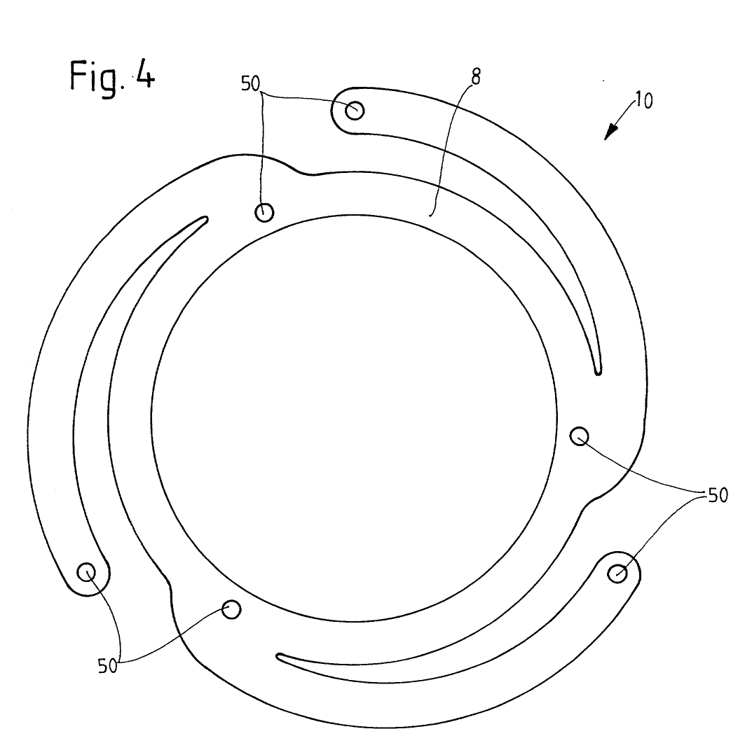

FIG. 4 shows a torque transmission element 10 in which a plurality of spring arms are connected at their ends to a common carrier 8. Distributed around the circumferential direction are openings 50 for attachment means which are provided for connection to a first functional unit. The openings 50 in the spring arms are provided for attachment means for the purpose of connection to a second functional unit. In a further refinement, it is also possible to connect the ends arranged radially on the outside by means of a further carrier.

As an alternative to the refinement shown in FIG. 4, the spring arms can also extend radially inward. Instead of the openings shown by way of example for the attachment means 50, for example for a screw connection, it is possible for the torque transmission element also to be connected to the adjacent functional units by any other known detachable or nondetachable method, for example by clamping, riveting, soldering or welding.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A torque transmission element for connecting a starter generator to a torque transmission unit so that said torque transmission unit can move axially relative to said starter generator, said torque transmission element comprising a tangential spring arm having one end arranged on the starter generator and another end arranged on the torque transmission unit.

2. A torque transmission element as in claim 1 wherein said tangential spring arm in the installed position has a dimension which is substantially larger in the radial direction than in the axial direction.

3. A torque transmission element as in claim 1 comprising a common carrier having a plurality of said tangential spring arms arranged thereon, said common carrier being connected to one of said starter generator and said torque transmission unit.

4. A series drive arrangement comprising
a starter generator,
a torque transmission unit arranged in series with said starter generator, said torque transmission unit being axially elastic with respect to the starter generator unit, and
a torque transmission element connecting said starter generator to a torque transmission unit so that said torque transmission unit can move axially relative to said starter generator, said torque transmission element comprising a tangential spring arm having one end arranged on the starter generator and another end arranged on the torque transmission unit.

5. A series drive arrangement as in claim 4 wherein said tangential spring arm in the installed position has a dimension which is substantially larger in the radial direction than in the axial direction.

6. A series drive arrangement as in claim 4 comprising a common carrier having a plurality of said tangential spring arms arranged thereon, said common carrier being connected to one of said starter generator and said torque transmission unit.
